(19) United States
(12) Patent Application Publication
(10) Pub. No.: US 2004/0131131 A1
(43) Pub. Date: Jul. 8, 2004

(54) Double-sampled, sample-and-hold circuit with downconversion

(76) Inventors: Charles T. Peach, Banks, OR (US); Krishnamurthy Soumyanath, Portland, OR (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/336,618

(22) Filed: Jan. 3, 2003

(51) Int. Cl. H04L 27/06

(52) U.S. Cl. 375/316

(57) ABSTRACT

A device (200, FIG. 2) includes receive hardware (204) which performs analog-to-digital conversion. In accordance with an embodiment of the invention, the receive hardware includes a pipelined analog-to-digital converter (320, FIG. 3). Sample-and-hold circuitry (410, FIG. 4) associated with the analog-to-digital converter is configured (FIGS. 8, and 12-14) and switched (FIG. 7) in a manner that provides intermediate frequency to baseband downconversion and skew-insensitive double-sampling.

### TECHNICAL FIELD

Embodiments of the invention pertain to the field of electronic circuits, and more particularly to analog-to-digital converters.

### BACKGROUND

In radio frequency (RF) and wired receivers, analog-to-digital converters (ADCs) are used to convert analog waveforms into digital signals that can be processed. Sample-and-hold circuitry within the ADC has a significant effect on the performance of the ADC. In order to gain higher bandwidth, specifications for the sample-and-hold circuitry are sometimes relaxed, resulting in lower ADC performance.

### BRIEF DESCRIPTION OF THE DRAWINGS

Embodiments of the invention are particularly pointed out and distinctly claimed in the concluding portion of the specification. However, embodiments of the invention, both as to organization and method of operation, together with objects, features, and advantages thereof, may best be understood by reference to the following detailed description when read with the accompanying drawings in which:

FIG. 1 is a simplified example of a communication system in which embodiments of the invention may be practiced;

FIG. 2 is a simplified block diagram of a communication device in accordance with an embodiment of the invention;

FIG. 3 is a simplified block diagram of receive hardware in accordance with an embodiment of the invention;

FIG. 4 is a simplified block diagram of an ADC in accordance with an embodiment of the invention;

FIG. 5 illustrates double-sampled, mixing sampling circuitry in accordance with an embodiment of the invention;

FIG. 6 illustrates a table showing a sequence of switch operations for the circuit of FIG. 5 in accordance with an embodiment of the invention;

FIG. 7 illustrates a table showing a sequence of switch operations in accordance with an alternate embodiment of the invention;

FIG. 8 illustrates double-sampled, skew-insensitive, mixing sampling circuitry in accordance with an embodiment of the invention;

FIG. 9 illustrates an example of a timing diagram showing the clock signals for the PHI 1, PHI 2, and PHI S switches in accordance with an embodiment of the invention;

FIG. 10 illustrates the effect of skew between the PHI 1 and PHI 2 sampling clocks;

FIG. 11 illustrates uniform sampling between the PHI 1 and PHI 2 sampling clocks, in accordance with an embodiment of the invention;

FIG. 12 illustrates a transistor-level schematic of double-sampled, skew-insensitive, mixing sampling circuitry in accordance with an embodiment of the invention;

FIG. 13 illustrates a transistor-level schematic of circuitry associated with a pipeline stage in accordance with an embodiment of the invention;

FIG. 14 illustrates a transistor-level schematic of circuitry associated with a pipeline stage in accordance with an alternate embodiment of the invention;

FIG. 15 illustrates a flowchart of a method for sampling in accordance with an embodiment of the invention;

FIG. 16 illustrates an ADC configuration for generating in-phase (I) and quadrature (Q) components;

FIG. 17 illustrates an example of a timing diagram showing the clock signals for mixing the I channel;

FIG. 18 illustrates an example of a timing diagram showing the clock signals for mixing the Q channel;

FIG. 19 illustrates a front end of I/Q demodulating, double-sampled, mixing sampling circuitry in accordance with an embodiment of the invention;

FIG. 20 illustrates an example of a timing diagram showing the clock signals for sampling and mixing the I and Q channels using the circuit illustrated in FIG. 19 in accordance with an embodiment of the invention; and

FIG. 21 illustrates a transistor-level schematic of circuitry associated with a pipeline stage in accordance with an embodiment of the invention.

### DETAILED DESCRIPTION

In the following detailed description, numerous specific details are set forth in order to provide a thorough understanding of embodiments of the invention. However, it will be understood by those skilled in the art, that embodiments of the invention may be practiced without these specific details. In other instances, well-known methods, procedures, components, and circuits have not been described in detail so as not to obscure the embodiments of the invention.

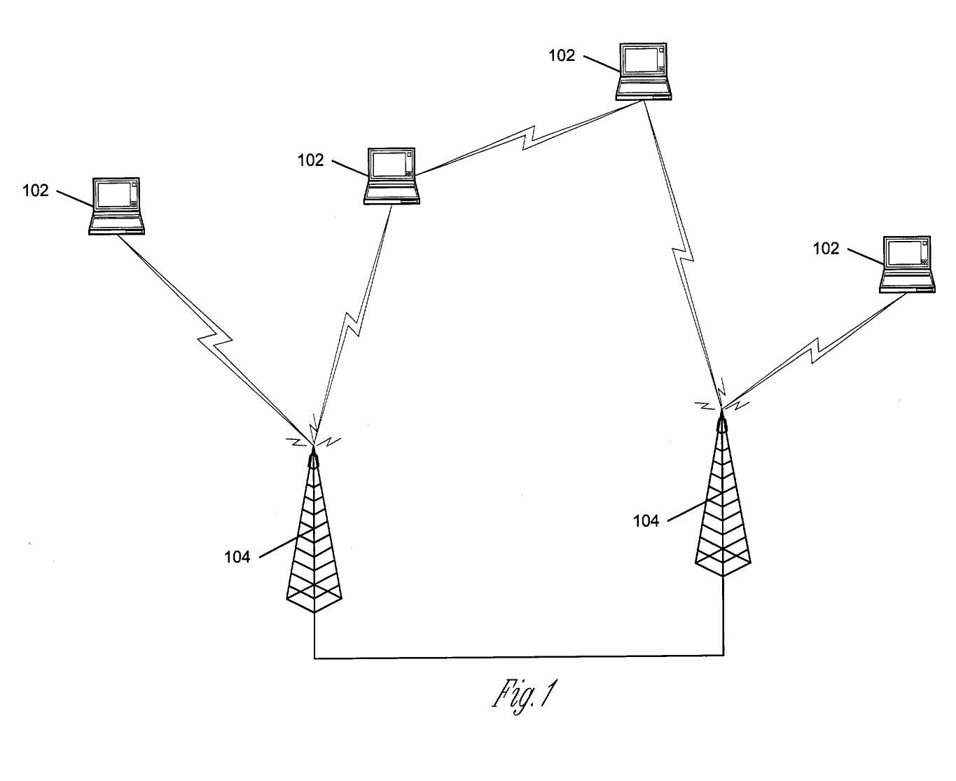

FIG. 1 is a simplified example of a communication system in which embodiments of the invention may be practiced. In the example system, communication devices 102 communicate with other devices 102 and/or with stations 104 over the medium of free space, which is commonly referred to as the “air interface.” The system could be, for example, a wireless local area network (WLAN), cellular telephone system, a narrowband or wideband communication network or many other types of wireless networks. Alternatively, embodiments of the invention could be incorporated into devices associated with a wired system (e.g., a cable network, wired LAN or other network or communication system).

A device 102 may be mobile, portable or stationary. For example, a device 102 may be a radio, a cellular telephone, a laptop computer, a desktop computer, or virtually any other one-way or two-way device with the capability of communicating with other devices 102 and/or stations 104 over a wired or wireless medium.

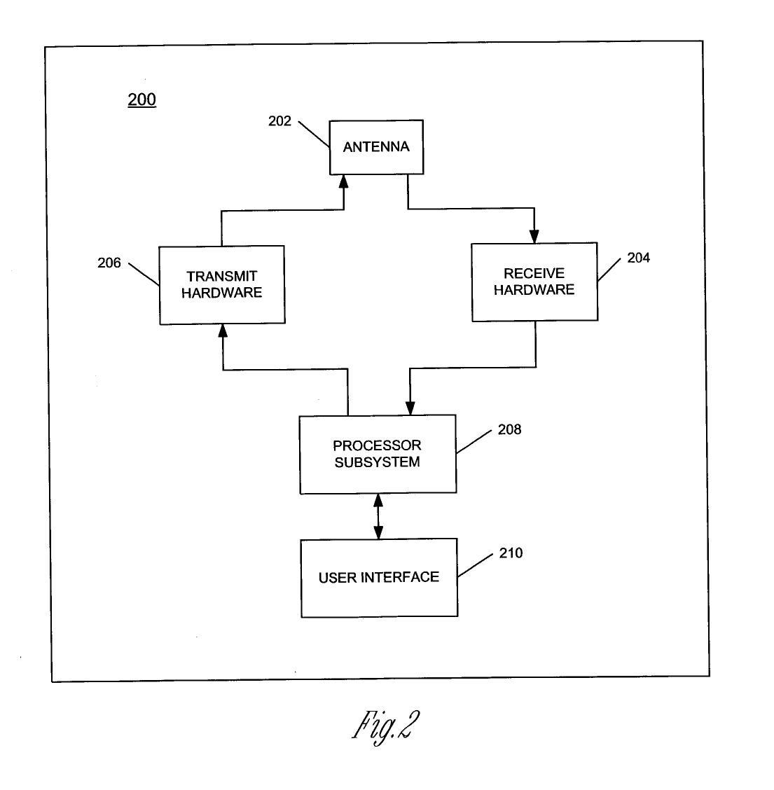

FIG. 2 is a simplified block diagram of a communication device 200 in accordance with an embodiment of the invention. In one embodiment, device 200 includes one or more antenna 202, receive hardware 204, transmit hardware 206, processor subsystem 208, and user interface 210. In an alternate embodiment, particularly when device 200 is a wired device, antenna 202 could be replaced by an interface to a wired network (e.g., a cable network). In other alternate embodiments, device 200 could be a one-way device that includes either receive hardware 204 or transmit hardware 206, but not both.

A user of device 200 receives outputs from and sends inputs to device 200 through the user interface 210. Depending on the type of device, user interface 210 could include one or more of a variety of different types of input/output devices. For example, input devices could include a microphone, camera, keyboard, keypad, touch screen, or any of a number of other types of devices. Output devices could include, for example, a speaker, display screen, or other types of devices. Alternatively, where no interaction with a user is provided by the device, device 200 may not include a user interface 210.

The information created by or destined for user interface 210 is processed by processor subsystem 208. Processor subsystem 208 could include, for example, one or more microprocessors, ASICs, memory devices, clocks, and/or other circuitry. Processor subsystem 208 may implement software that enables digital data to be processed. For example, if device 200 is a cellular telephone, processor subsystem 208 could receive voice data from a speaker associated with the user interface 210, and could convert that voice data into a format suitable for transmission by transmit hardware 206. Similarly, processor subsystem 208 could receive digital data from receive hardware 204, and convert the data into a voice signal that can be provided to a user via a speaker associated with user interface 210.

Transmit hardware 206 converts digital data from processor subsystem 208 into an analog signal for transmission by antenna 202. Transmit hardware 206 could include, for example, a digital-to-analog converter (DAC), a clock, and other circuitry.

Antenna 202 receives analog signals present on the air interface and sends those signals to receive hardware 204. In addition, antenna 202 receives analog signals from transmit hardware 206 and sends those signals out over the air interface.

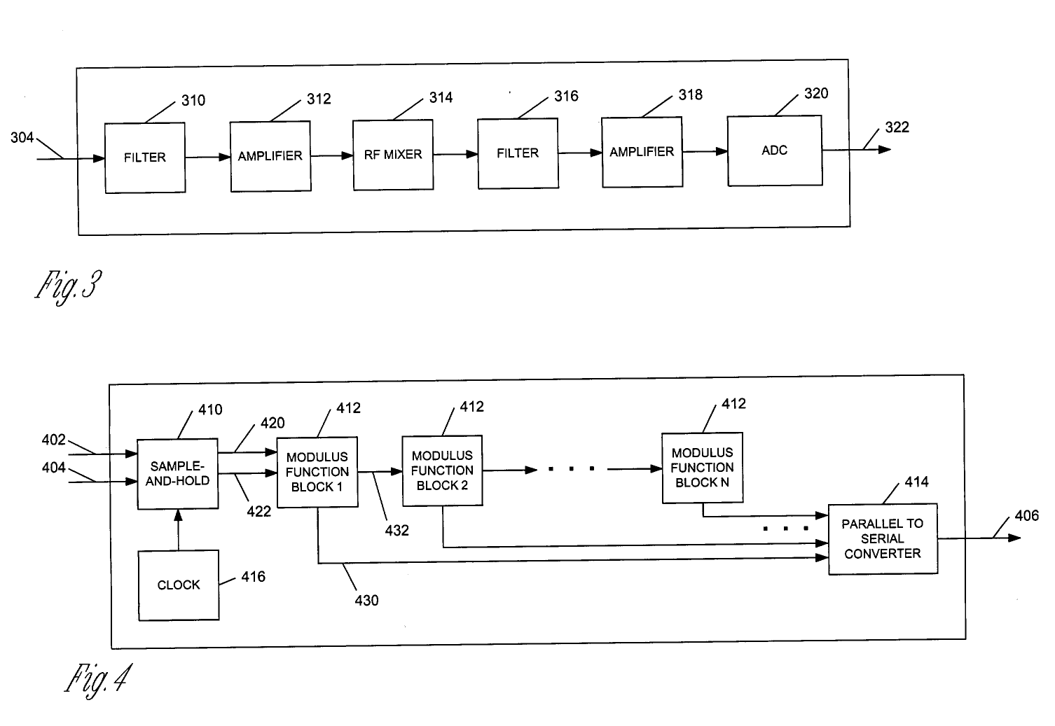

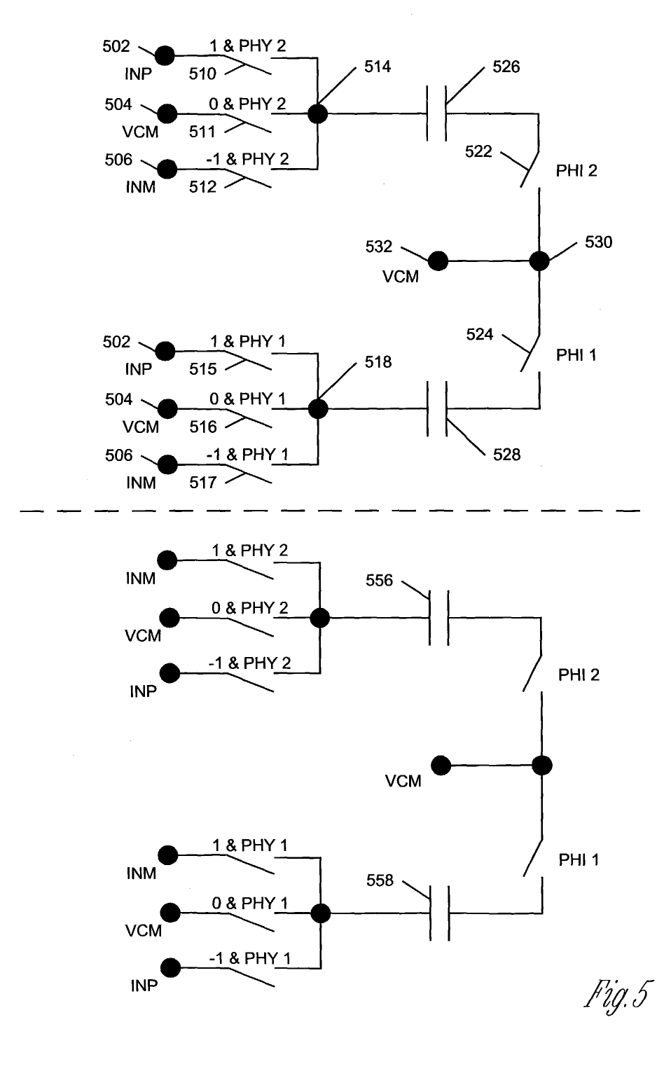

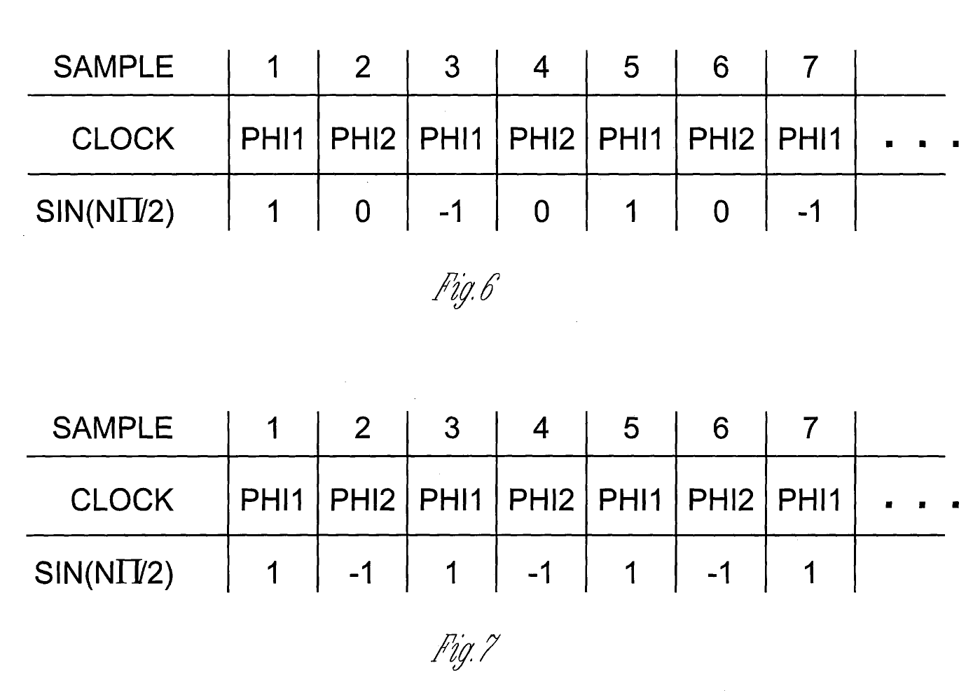

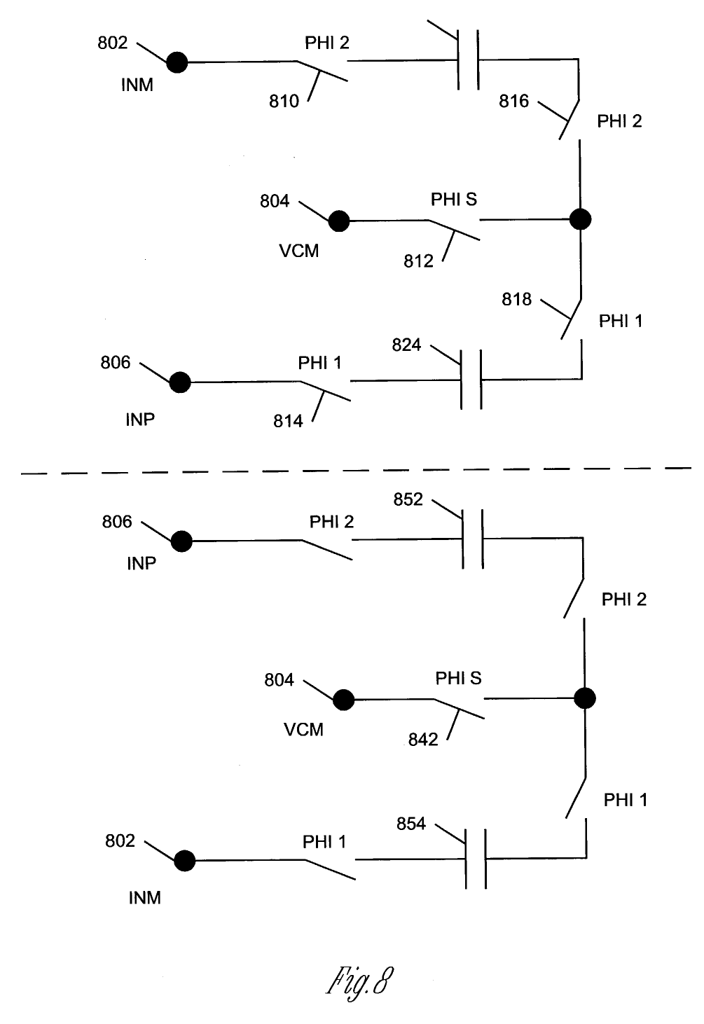

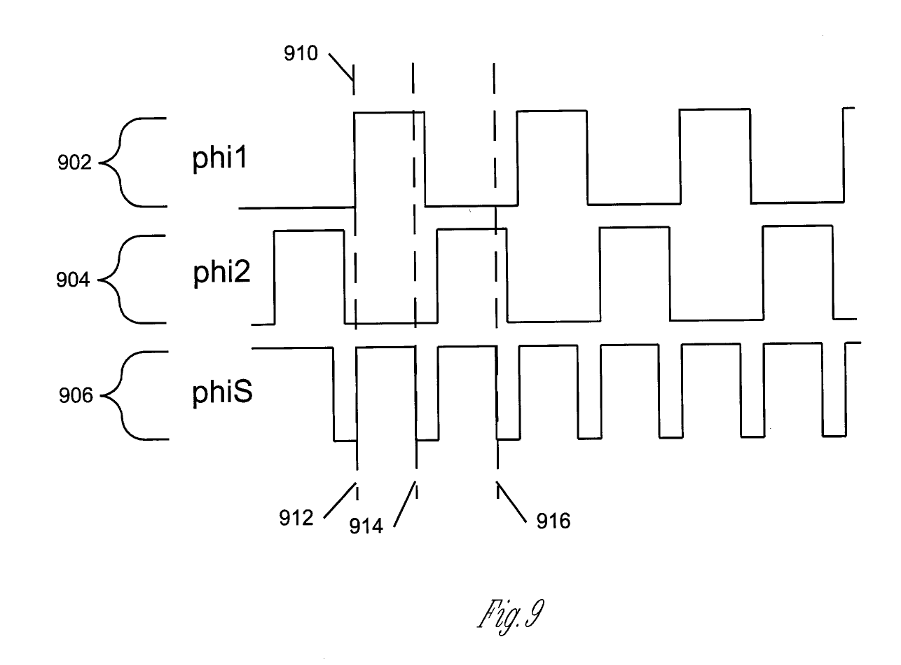

Receive hardware 204 converts analog information from antenna 202 into digital data for consumption by processor subsystem 208. Receive hardware 204 is described in more detail later in conjunction with FIG. 3. In one embodiment, receive hardware 204 includes an analog-to-digital converter (ADC). The ADC is a pipelined ADC, in one embodiment, which includes a plurality of differential comparators (e.g., modulus function blocks), described later in conjunction with FIG. 4. In addition, in one embodiment, the ADC includes sample-and-hold circuitry, which double-samples and downconverts the incoming analog signals in a skew-insensitive manner. In one embodiment, the downconversion achieves intermediate frequency (IF) to baseband (BB) mixing (i.e., downconversion), although downconversion from or to other frequencies also could be achieved using the methods and apparatus of the various embodiments.

The sample-and-hold circuitry of a receiver has a significant effect on the performance of an ADC. In some cases, specifications for the sample-and-hold circuitry are relaxed in order to achieve higher bandwidths. Unfortunately, this reduces the performance of the ADC, resulting in the production of degraded digital data.

In accordance with an embodiment of the invention, the sample-and-hold circuitry employs a double-sampled architecture, which allows for a doubling in bandwidth and conversion efficiency. This double-sampled architecture uses multiple sampling clocks. The possibility of switching noise from a skew between the sampling clocks is reduced by including IF-to-BB mixing within the sample-and-hold circuitry, in one embodiment. IF-to-BB mixing presents a desirable feature in the sample-and-hold circuitry, because subsequent processing elements (e.g., elements within processor subsystem 208) are not required to perform digital floating-point multiplication in order to downconvert to baseband. Accordingly, the sampling circuitry of the various embodiments permits a substantial bandwidth improvement without substantial signal degradation. In addition, the subsequent processing elements can be simpler and less expensive, without the need for digital floating-point multiplication capabilities. This is achieved by the various embodiments without increasing the amount of power that the receive hardware consumes, and without increasing the cost of the receive hardware.

FIG. 3 is a simplified block diagram of receive hardware (e.g., receive hardware 204, FIG. 2) in accordance with an embodiment of the invention. In one embodiment, receive hardware includes a channel select filter 310, a first amplifier 312, a radio-frequency (RF) mixer 314, an anti-alias filter 316, a second amplifier 318, and an ADC 320.

Channel select filter 310 receives an analog input signal 304 from a signal source (e.g., antenna 202, FIG. 2). In one embodiment, filter 310 is a band-pass filter used to narrow the input signal to the band of interest.

The filtered signal is then amplified, in one embodiment, by amplifier 312.

Because the power level of the input signal may be very low, amplifier 312 amplifies the input signal, if necessary, to a power level sufficient for other receive hardware components to process. In one embodiment, amplifier 312 is a low-noise amplifier.

RF mixer 314 then mixes the amplified signal down to a frequency that the ADC 320 can process, which will be referred to herein as the input ADC frequency.

The input ADC frequency can be an intermediate frequency that is larger than baseband. For example, the intermediate frequency can be in a range of 1-500 MHz, although the value of the intermediate frequency can be larger or smaller than a value within this range, in other embodiments.

Filter 316 then processes the mixed signal to remove images introduced in the mixing process, in one embodiment. Filter 316 is an anti-alias filter, which could be a low-pass or band-pass filter, in various embodiments.

The filtered signal is then fed to amplifier 318. In one embodiment, amplifier 318 is a variable gain amplifier (VGA), which detects the power level of the incoming signal, and adjusts that power level upward or downward, in order to better utilize the dynamic range of the ADC 320.

ADC 320 then converts the analog signal into digital information 322. In one embodiment, ADC 320 is a pipelined ADC, which converts each sample into a fixed number of bits (e.g., 12 bits), which represent the sample. The digital information 322 produced by the ADC 320 for each sample is a serial, N-bit value, where N is an integer. Using a pipelined ADC, there is no interaction between samples taken before or after a particular sample. This is in contrast to a sigma-delta converter, which provides a serial bit stream of “1”s and “0”s, the density of which represents the input signal. Generally, a pipelined ADC performs better than a sigma-delta converter for higher bandwidth applications.

In one embodiment, ADC 320 performs three functions. First, it performs analog-to-digital conversion, translating a continuous analog signal into digital “1”s and “0”s. Second, it performs IF-to-BB mixing (or other downconversion), which eliminates the need for a floating-point mixer associated with the digital processor. Third, the ADC 320 separates the I and Q channels, in one embodiment. Alternatively, the ADC 320 does not separate the I and Q channels.

FIG. 4 is a simplified block diagram of an ADC in accordance with an embodiment of the invention. In one embodiment, the ADC includes sample-and-hold circuitry 410, N modulus function or differential comparator blocks 412, a parallel-to-serial converter 414, and one or more clocks 416.

In one embodiment, the ADC receives one or more voltage input signals 402, 404 from a previous element of the receive hardware, such as amplifier 318 (FIG. 3). In one embodiment, a first of the input signals 402 is considered a positive input “INP”, and a second of the input signals 404 is considered a negative input, “INM”. The actual voltages are not necessarily positive or negative,. The difference between INP and INM at any point in time represents the information that is being sampled. Thus, for example, if INP equals 0.8 volts, and INM equals 0.3 volts, the difference between the two would be 0.5 volts.

Sample-and-hold circuitry 410 receives the input voltage signals 402, 404, and samples those signals at a frequency that is determined by a clock signal from one or more clocks 416. In one embodiment, sample-and-hold circuitry 410 produces two output signals 420, 422. These output signals, OUTP 420 and OUTM 422, are provided to the first stage of the pipeline, or to modulus function block 1 412. In one embodiment, OUTP 420 and OUTM 422 are approximately reflections of one another.

Each modulus function block 412 divides its input signals by an integer number. For example, in one embodiment, each block 412 is a modulus of 2 block. In other embodiments, each block 412 could be a modulus of 3, 4, or some other number.

As a modulus of 2 block 412, each modulus function block 412 divides the input signals by 2. If the result is greater than 12, then the block outputs a bit 430 having a logic value of “1”. Conversely, if the result is less than ½, then the block outputs a bit 430 having a logic value of “0”. A remainder of the division process is then passed as an input 432 to the next modulus function block 412, which performs a similar function.

Accordingly, each modulus function block 412 produces a single bit, with modulus function block 1 producing the most significant bit, and modulus function block N producing the least significant bit. As an example, using 1-bit per stage converters, if the number of bits in a sample is N, where N is an integer, then the pipelined ADC will include N modulus function blocks 412. For example, if the number of bits in a sample is 12, then there are 12 modulus function blocks 412. In other converter embodiments, the converter may produce more bits in a stage, and therefore have less than N stages.

The bits produced by the modulus function blocks 412 are sometimes collected by parallel-to-serial converter 414. A stream of serial bits is then output 406 to a digital or general-purpose processor (e.g., processor subsystem 208, FIG. 2), for further processing. As was described previously, the sample-and-hold circuitry 410 performs IF-to-BB conversion, in one embodiment. Accordingly, this digital or general-purpose processor need not include the capability to perform floating-point multiplication. This reduces the cost of the processor, and thus the device as a whole.

The circuitry associated with the sample-and-hold block 410 will now be described in accordance with various embodiments of the invention. Although the sample-and-hold circuitry features are shown at the front end of the pipelined architecture (i.e., before the most significant modulus function block 412), some or all features could be performed at other points within the pipeline, using similar circuitry.

FIG. 5 illustrates double-sampled, mixing sampling circuitry in accordance with an embodiment of the invention. In one embodiment, the circuit includes two half circuits, where a first half circuit is shown above the dashed line of FIG. 5, and a second half circuit is shown below the dashed line of FIG. 5. The second half circuit is essentially an inverse version of the first half circuit, in one embodiment. For ease of illustration, FIG. 5 does not show the amplifier used for holding the sampled voltages.

According to a pre-defined input sequence described later in conjunction with FIG. 6, input nodes 514, 518 of the first half circuit sequentially receive INP from nodes 502, common mode voltage (VCM) from nodes 504, and INM from nodes 506. INP and INM are received from a signal source (e.g., amplifier 318, FIG. 3). Alternatively, the first half circuit could receive INP and INM from another portion or stage of the ADC. Besides being provided at nodes 504, VCM is also provided at node 532 of the first half circuit.

The first half circuit includes at least two capacitors 526, 528. The charge on each of these capacitors 526, 528 is affected when the adjacent switches are closed. For example, the voltage differential between node 514 and VCM is trapped across capacitor 526 when PHI 2 switch 522 and one of switches 510, 511 or 512 are off. Similarly, the voltage differential between node 518 and VCM is trapped across capacitor 528 when PHI 1 switch 524 and one of switches 515, 516, or 517 are off.

The second half circuit also includes at least two capacitors 556, 558, and adjacent PHI 1 and PHY 2 switches. The second half circuit functions in conjunction with the first half circuit to provide differential input signals. The outputs of the first half circuit, OUTP, and the second half circuit OUTM, basically consist of the charges trapped on capacitors 526, 528, 556, and 558.

Using switches that are not shown in FIG. 5, the charge on one of the first half circuit capacitors is provided to an amplifier, not shown, while the other first half circuit capacitor is charging. This is also the case for the second half circuit capacitors. Thus, for example, while capacitors 526 and 556 are charging (i.e., the PHY 2 switches are closed and the PHI 1 switches are open), the charges on capacitors 528 and 558 are being read into and held by the amplifier.

The switching network of FIG. 5 functions as an IF-to-BB mixer when f_{IF}=(n±¼)fₛ, where fₛ is the sampling frequency (e.g., baseband) and f_{IF} is the intermediate frequency. When the sampling frequency and the intermediate frequency adhere to this relationship, mixing simplifies to a multiplication by sin(nπ/2) or the pattern [ . . . 1, 0, −1, 0 . . . ], since n is an integer. Multiplying a differential signal by “−1” is achieved, in one embodiment, by sampling the opposite channel. This is analogous to swapping the positive INP and negative INM terminals. Alternatively, the input signal could be inverted in some other manner. Multiplying by “0” is achieved, in one embodiment, by sampling the common mode voltage, VCM. Multiplying by “1” indicates no modification to the input signal.

To exemplify the switching configuration, FIG. 6 illustrates a table showing a sequence of switch operations for the circuit of FIG. 5 in accordance with an embodiment of the invention. The “sample” row indicates which sampling incident is occurring, beginning from 1 and counting upward by an integer of 1, ad infinitum. The “clock” row indicates which set of switches, PHI 1 or PHI 2, are closed during a particular sampling incident, and the “sin(nπ/2)” row indicates what value the input signal should be multiplied by, which in one embodiment is either “1”, “0” or “−1”. For example, during sample number four, the PHI 2 switches 511 and 522 (FIG. 5) close, and VCM 504 is provided at node 514 to the top plate of capacitor 526. Because VCM 532 also exists at the bottom plate of capacitor 526, no voltage differential exists across capacitor 526, and it is as if the input voltage were multiplied by “0”.

Close inspection of FIG. 6 shows that the same voltage, VCM, is converted every other clock cycle. In other words, it is as if the input voltage is multiplied by “0” every other cycle, or whenever the PHI 2 switches are closed.

In an alternate embodiment, VCM is converted as a foreground routine, and the sample network skips the “0” terms during runtime. Later, the “0” can be reintroduced back into the data stream (e.g., by the processor subsystem). This technique, which is illustrated and described in more detail in conjunction with FIGS. 7 and 8, allows a doubling in the intermediate frequency relative to the sample rate. Accordingly, higher bandwidths can be supported without a degradation in signal quality.

FIG. 7 illustrates a table showing a sequence of switch operations in accordance with an alternate embodiment of the invention. The table is similar to the table of FIG. 6, except that the “0” terms have been removed from the sin(nπ/2) row, and all other sin(nπ/2) terms have been compressed. Accordingly, the sin(nπ/2) row indicates that the input signal is multiplied by either “1” or “−1”.

As FIG. 7 indicates, when the PHI 1 switches are closed, the input signal always is multiplied by “1” (i.e., the input signal INP is sampled). Also, when the PHI 2 switches are closed, the input signal always is multiplied by “−1”. Because the input signal is a differential signal, in one embodiment, multiplying the input signal by “−1” can be achieved by sampling INM. In one embodiment, the front end switching of the circuit of FIG. 5 is condensed to provide INP to the capacitor adjacent to the PHI 1 switches, and to provide INM to the capacitor adjacent to the PHI 2 switches, as illustrated in FIG. 8.

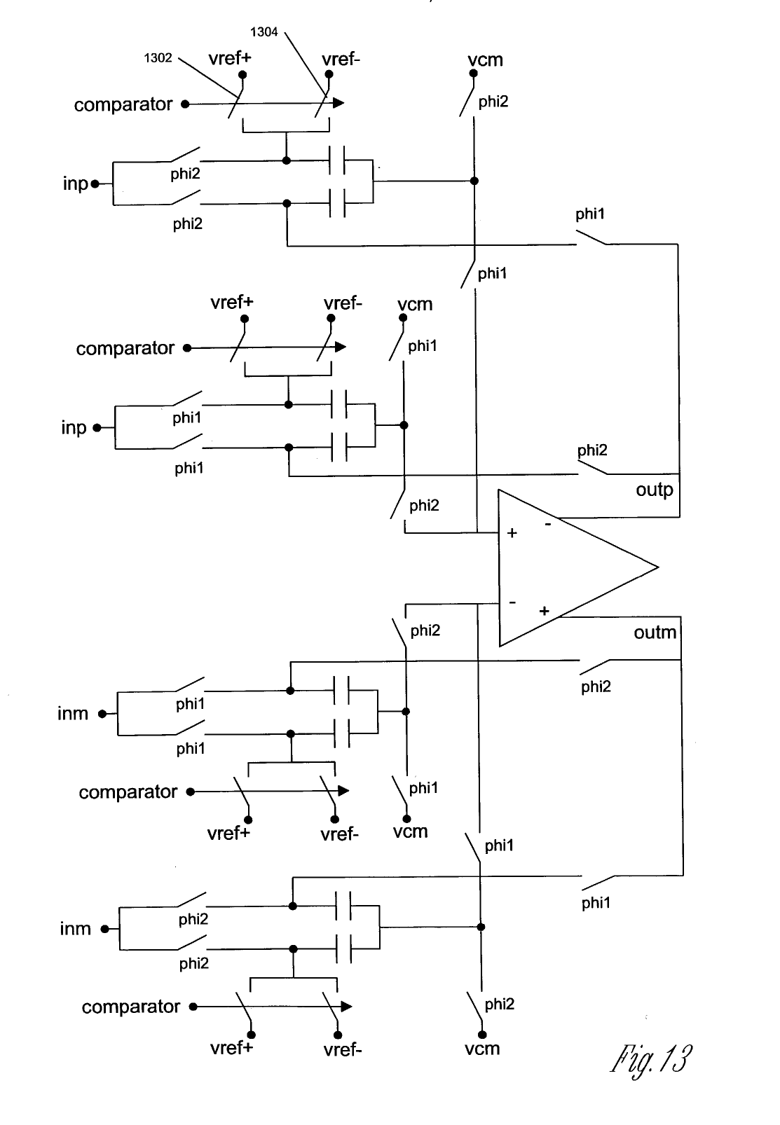

FIG. 8 illustrates double-sampled, skew-insensitive, mixing sampling circuitry in accordance with an embodiment of the invention. As with the circuit described in conjunction with FIG. 5, in one embodiment, the circuit of FIG. 8 includes two half circuits, where a first half circuit is shown above the dashed line of FIG. 8, and a second half circuit is shown below the dashed line of FIG. 8. The second half circuit is essentially an inverse version of the first half circuit, in one embodiment. For ease of illustration, FIG. 8 does not show the amplifier used for holding the sampled voltages. This amplifier is described and shown later in conjunction with FIGS. 12, 13, and 14.

The first and second half circuits receive INM at nodes 802 and INP at nodes 806 from a signal source (e.g., amplifier 318, FIG. 3). Alternatively, the circuit could receive INM and INP from another portion or stage of the ADC. In addition, VCM is input to the first half circuit and the second half circuit at nodes 804.

The first half circuit includes at least two capacitors 822, 824. The charge on each of these capacitors 822, 824 is affected when the adjacent switches are off. For example, the difference between the INM voltage present at node 802 and VCM 804 is trapped across capacitor 822 when PHI 2 switches 810 and 816 are off. Accordingly, capacitor 822 is referred to herein as the INM capacitor. Similarly, the difference between the INP voltage present at node 806 and VCM 804 is trapped across capacitor 824 when PHI 1 switches 814 and 818 are off. Accordingly, capacitor 824 is referred to herein as the INP capacitor.

The second half circuit also includes at least two capacitors 852, 854, and adjacent PHI 1 and PHY 2 switches. The second half circuit functions in conjunction with the first half circuit to provide double-sampling of the input signals. The outputs of the first half circuit, OUTP, and the second half circuit OUTM, basically consist of the charges on capacitors 822, 824, 852, and 854.

Using switches that are not shown in FIG. 8, the charge on one of the first half circuit capacitors are provided to an amplifier, not shown, while the other capacitor is charging. This is also the case for the second half circuit capacitors. Thus, for example, while capacitors 822 and 852 are charging (i.e., the PHY 2 switches are closed and the PHI 1 switches are open), the charges on capacitors 824 and 854 are being read into and held by the amplifier.

The circuit of FIG. 8 provides an additional feature of skew-insensitivity, as well, by including PHI S switches 812, 842, in one embodiment. The opening of PHI S switches 812, 842 preempts the opening of the PHI 1 and PHI 2 switches, therefore providing a single sampling instant, and reducing skew-induced harmonics that may otherwise occur with a double-sampling circuit. Basically, PHI S switches 812, 842 envelope the skew that might exist between the PHI 1 and PHI 2 switches.

FIG. 9 illustrates an example of a timing diagram showing the clock signals 902, 904, 906 for the PHI 1, PHI 2, and PHI S switches, respectively, in accordance with an embodiment of the invention. The PHI switches associated with each clock signal are closed on the rising edge of the clock signal, and are opened on the falling edge of the clock signal.

As indicated in FIG. 8, when the PHI S switches 812, 842 are open, the bottom plate of the capacitors 822, 824, 852, 854 are separated from VCM (i.e., they are floating). When the bottom plate is floating, the capacitor does not charge, regardless of whether or not the top plate is floating or connected to a signal source. Accordingly, the PHI S switches 812, 842 can be used to define the charging periods of the capacitors, and thus the sampling moments. Specifically, the sampling moment of a capacitor in its charging phase (i.e., when its top plate is connected) is the moment when the PHI S switch on its bottom plate opens, thus terminating the charging phase and beginning the holding phase.

For example, referring again to FIG. 9, at time 910, the PHI 1 switches close (e.g., switches 814, 818, FIG. 8). Shortly thereafter, at time 912, the PHI S switches close (e.g., switches 812, 842, FIG. 8), beginning the charging phase of the PHI 1 capacitors (e.g., capacitors 824, 854, FIG. 8). When the PHI S switches subsequently open, at time 914, the charging phase of the PHI 1 capacitors stops, and the voltage is held at the then-current value of the voltage on the top plate of the capacitor. Accordingly, the opening of the PHI S switches defines the sampling moment. As FIG. 9 indicates, the PHI 2 capacitors are similarly charged, and the sampling moment of the voltage across the PHI 2 capacitors occurs at the next falling edge of the PHI S clock, or at time 916.

Without the PHI S clock, the sampling moments of the PHI 1 and PHI 2 capacitors would be defined by the falling edges of the PHI 1 and PHI 2 clocks. Because the clocks are separate, their falling edges might not occur exactly 180 degrees out of phase with each other. With the PHI S clock defining the sampling moment of the PHI 1 and PHI 2 capacitor charges, the harmonics that might otherwise be introduced due to the PHI 1 and PHI 2 clock skews are eliminated.

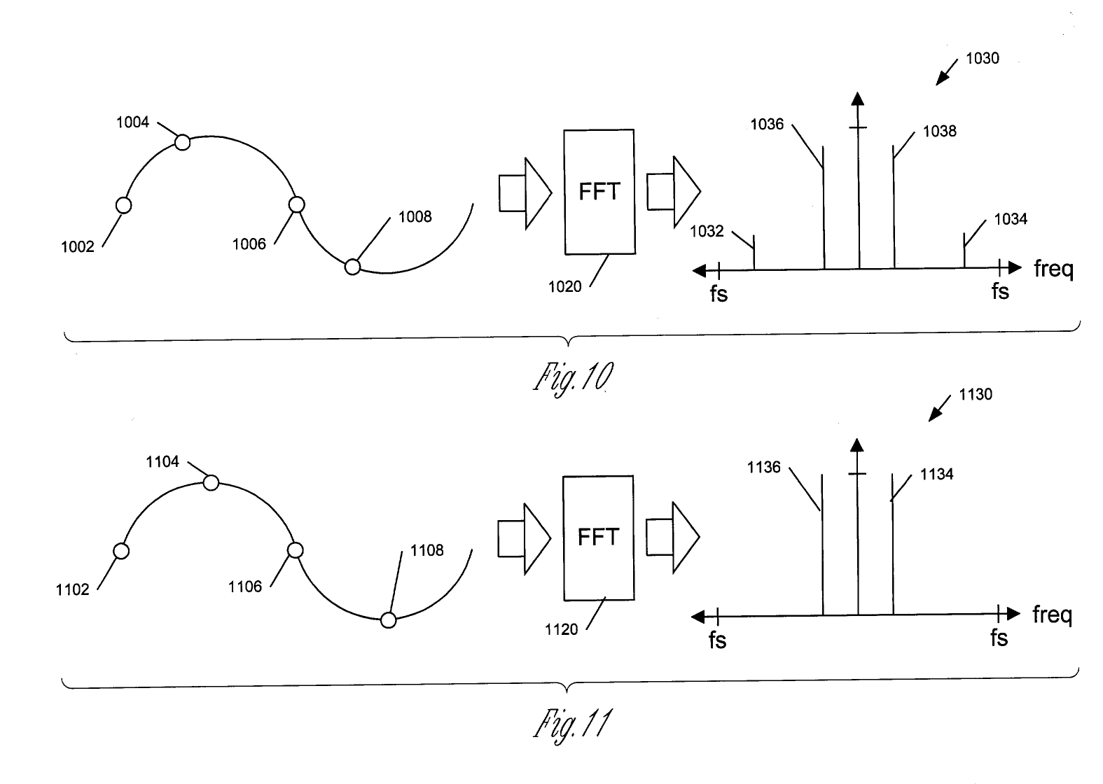

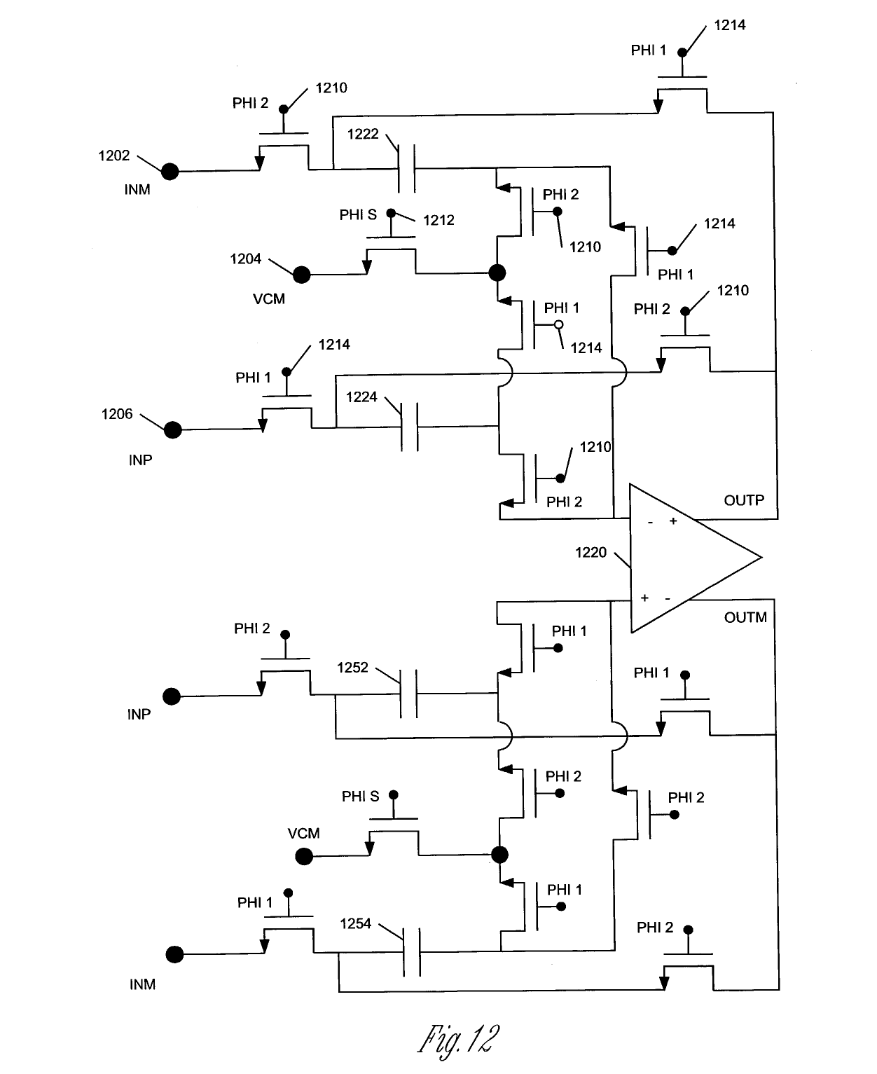

The operation of the PHI 1, PHI 2, and PHI S switches in the manner described in conjunction with FIG. 9 provide a single sampling instant, thus achieving more uniform sampling. This reduces skew-induced harmonics that may otherwise occur with a double-sampling circuit. FIGS. 10 and 11 illustrate the advantage of achieving more uniform sampling.

FIG. 10 illustrates the effect of skew between the PHI 1 and PHI 2 sampling clocks, when a PHI S clock is not implemented. Points 1002 and 1006 represent sampling points along a sine wave, when the PHI 1 capacitors (e.g., capacitors 824, 854, FIG. 8) are sampled, and points 1004 and 1008 represent sampling points along the sine wave, when the PHI 2 capacitors (e.g., capacitors 822, 252, FIG. 8) might be sampled. As the Figure shows, a non-uniform distance could exist between the PHY 1 capacitor sampling points 1002, 1006, and the intervening PHI 2 capacitor sampling point 1004. If a Fast Fourier Transform (FFT) 1020 were applied, then the resulting spectral representation 1030 of the sampled data would include undesirable harmonics 1032, 1034, along with the desired information 1036, 1038.

When the PHI S envelope switches (e.g., switches 812, 842, FIG. 8) are used to envelope the skew that might otherwise exist between the PHI 1 and PHI 2 clocks, these harmonics are reduced or eliminated. FIG. 11 illustrates uniform sampling between the PHI 1 and PHI 2 sampling clocks, in accordance with an embodiment of the invention. Points 1102 and 1106 represent sampling points along a sine wave, when the PHI 1 capacitors (e.g., capacitors 824, 854, FIG. 8) are sampled, and points 1104 and 1108 represent sampling points along the sine wave, when the PHI 2 capacitors (e.g., capacitors 822, 252, FIG. 8) are sampled. In contrast to the sampling instances illustrated in FIG. 10, a uniform distance exists between the PHY 1 capacitor sampling points 1102, 1106, and the intervening PHI 2 capacitor sampling point 1104. If an FFT 1120 were applied, then the resulting spectral representation 1130 of the sampled data would includes only the frequencies associated with the desired data 1136, 1138, and would not include undesirable, skew-induced harmonics.

FIG. 12 illustrates a transistor-level schematic of double-sampled, skew-insensitive, mixing sampling circuitry in accordance with an embodiment of the invention. The circuit of FIG. 12 corresponds to the circuit of FIG. 8, but it also shows amplifier 1220, used to hold the sampled voltages, and also an embodiment of switching circuitry wrapped around amplifier 1220, which determines when charges on capacitors 1222, 1224, 1252, and 1254 are provided to amplifier 1220.

Referring to the first half circuit, which includes the circuitry above amplifier 1220, when the PHI 2 switches 1210 and PHI S switch 1212 are closed, the difference between INM at node 1202 and VCM is charged on capacitor 1222, and the charge on capacitor 1224 is read into amplifier 1220 as signal OUTP. Similarly, when the PHI 1 switches 1214 and PHI S switch 1212 are closed, the difference between INP at node 1206 and VCM is charged on capacitor 1224, and the charge on capacitor 1222 is read into amplifier 1220 as signal OUTP.

Referring to the second half circuit, which includes the circuitry below amplifier 1220, a similar, but inverse, operation occurs simultaneously on the second half circuit to provide double-sampling. At amplifier 1220, the output voltage from the second half circuit is inverted from the output voltage from the first half circuit, to provide output signal OUTM.

The circuit of FIG. 12 could be implemented, for example, in the sample-and-hold circuitry that occurs before the pipeline (e.g., modulus function blocks 412, FIG. 4). In an alternate embodiment, some or all of the features associated with the circuit of FIG. 12 could be implemented in one of the stages (e.g., one of the modulus blocks 412) of the pipeline, with a few minor adjustments to the circuitry.

FIG. 13 illustrates a schematic of circuitry associated with a pipeline stage (e.g., a modulus function block 412, FIG. 4) that provides double-sampling in accordance with an embodiment of the invention. The circuitry shown in FIG. 13 provides double-sampling, and also implements the modulus function using comparator switches 1302, 1304, which are connected, respectively, to positive and negative reference voltages, VREF+ and VREF−. These switches 1302, 1304 and the reference voltages are used for making a determination of whether the difference between the INP and INM voltages is greater than or less than VCM (i.e., the analog ground reference voltage). If the difference is greater than VCM, then the comparator could indicate a high state, and if the difference is less than VCM, then the comparator could indicate a low state, or vice versa.

In the embodiment shown, PHI S switches used to envelope the PHI 1 and PHI 2 clocks are not implemented, as these switches can be implemented in the sample-and-hold circuitry that precedes the pipeline. In another embodiment, the PHI S switches could be incorporated into the circuitry of the pipeline stage.

In addition, the embodiment shown in FIG. 13 does not provide for downconversion (e.g., IF-to-BB downconversion). The downconversion also could be implemented in the preceding sample-and-hold circuitry, or it could be implemented elsewhere. In an alternate embodiment of that shown in FIG. 13, a pipeline stage could implement downconversion as well as double-sampling.

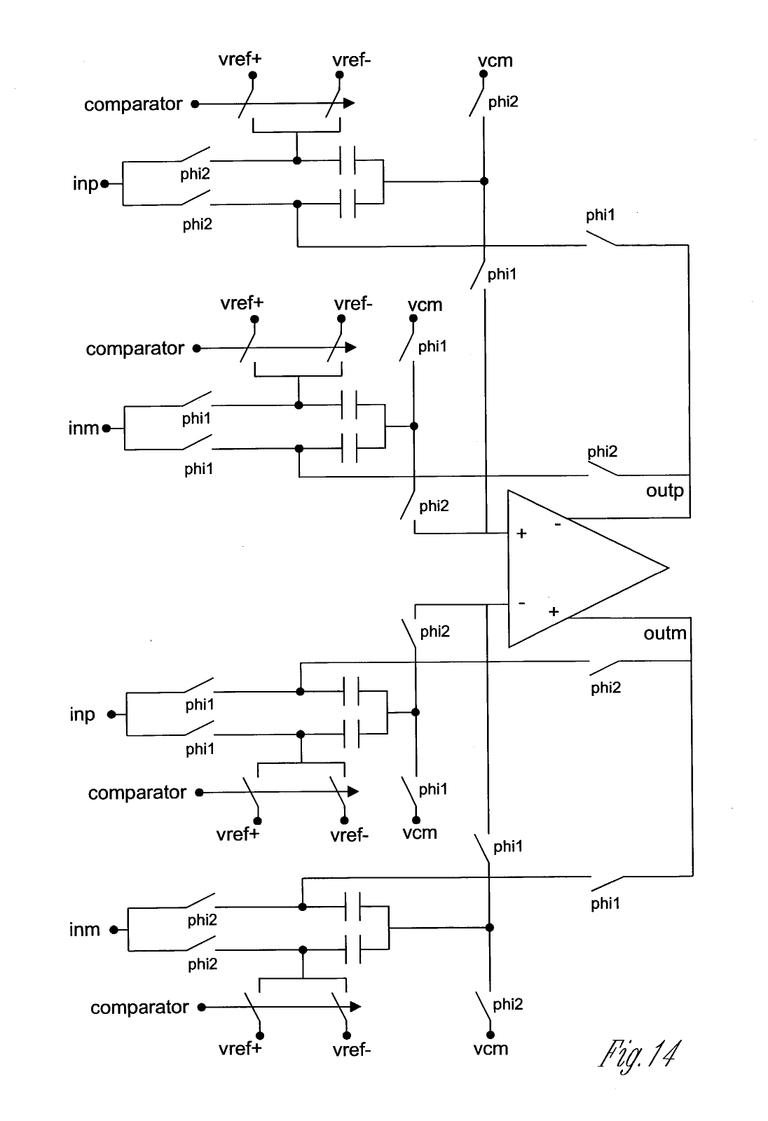

FIG. 14 illustrates a schematic of circuitry associated with a pipeline stage (e.g., a modulus function block 412, FIG. 4) that provides double-sampling and downconversion in accordance with an alternate embodiment of the invention. The circuitry illustrated in FIG. 14 is substantially the same as the circuitry illustrated in FIG. 13, except that the input signals, INP and INM are switched from the configuration of FIG. 13. Using a switching configuration similar to that described in conjunction with FIG. 7, the circuitry would achieve downconversion, as well as the double-sampling. If the downconversion is implemented in a pipeline stage, as illustrated in FIG. 14, it may be undesirable to include downconversion also in the sample-and-hold circuitry.

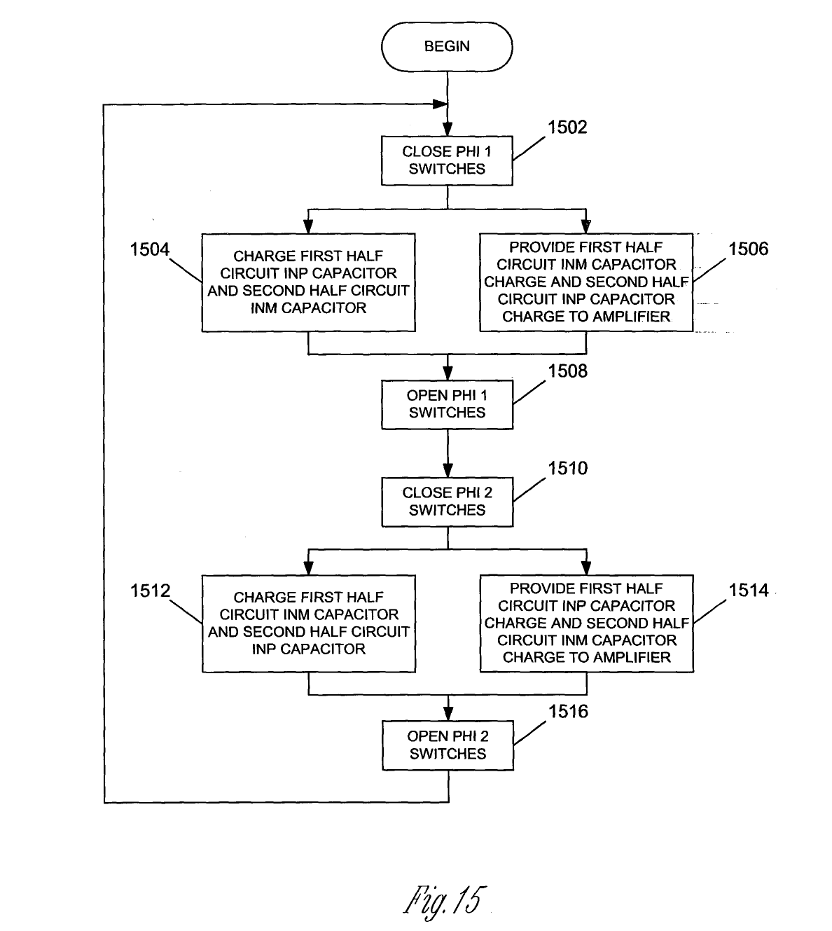

FIG. 15 illustrates a flowchart of a method for sampling in accordance with an embodiment of the invention. The method begins when all switches are open.

Then, in block 1502, the PHI 1 switches (e.g., switches 1214, FIG. 12) are closed. In one embodiment, this results in two things occurring simultaneously. First, in block 1504, double-sampling occurs when the INP capacitor (e.g., capacitor 824, 1224) of the first half circuit, and the INM capacitor (e.g., capacitor 854, 1254) of the second half circuit are charged. Second, in block 1506, the charge on the first half circuit INM capacitor (e.g., capacitor 822, 1222) and the charge on the second half circuit INP capacitor (e.g., capacitor 852, 1252) are provided to the amplifier (e.g., amplifier 1220). Then, in block 1508, the PHI 1 switches are opened.

In block 1510, the PHI 2 switches (e.g., switches 1210) are closed. Again, in one embodiment, this results in two things occurring simultaneously. First, in block 1512, double-sampling occurs when the INM capacitor (e.g., capacitor 822, 1222) of the first half circuit, and the INP capacitor (e.g., capacitor 852, 1252) of the second half circuit are charged. Second, in block 1514, the charge on the first half circuit INP capacitor (e.g., capacitor 824, 1224) and the charge on the second half circuit INM capacitor (e.g., capacitor 854, 1254) are provided to the amplifier (e.g., amplifier 1220). Then, in block 1516, the PHI 2 switches are opened. The process then repeats until sampling is completed. Although the flowchart shows the PHI 1 switches being closed first, alternatively, the PHI 2 switches could be closed first.

The foregoing description of various embodiments does not discuss separating in-phase (I) and quadrature (Q) components that could be combined within an incoming signal. In other embodiments of the invention, discussed below, the I and Q components can simultaneously be separated while providing skew-insensitive, double-sampling with IF-to-BB mixing.

When I and Q components are combined in a signal, they exist in the signal out of phase from one another. Accordingly, I and Q components can be separated by mixing or sampling the input signal at different phases of a sampling period. For example, the Q components of a signal could be out of phase from the I components by ¼ period.

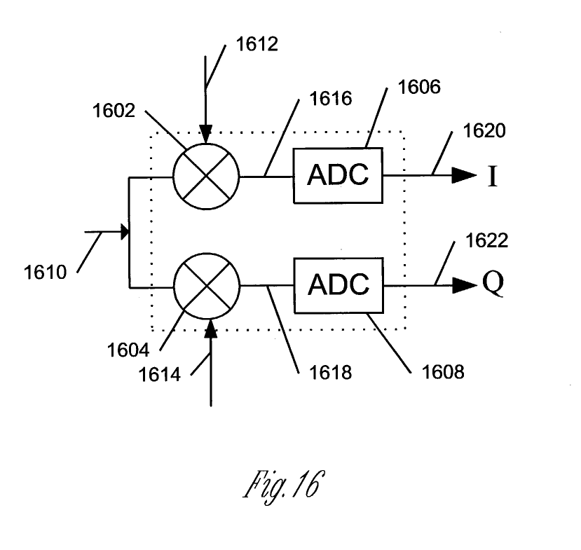

FIG. 16 illustrates a configuration for separating and sampling I and Q components using two mixers 1602, 1604, and two ADCs 1606, 1608. The input signal 1610 can be an intermediate frequency signal having both I and Q components.

The signal 1610 is provided to mixers 1602 and 1604. When the clock signal 1612 provided to mixer 1602 is out of phase from the clock signal 1614 provided to mixer 1604 by an appropriate phase shift, the resulting downconverted signals 1616, 1618 provided to ADCs 1606, 1608, respectively, are separated into their I and Q components. Accordingly, ADC 1606 generates digitized I samples 1620, and ADC 1608 generates digitized Q samples 1622.

FIG. 17 illustrates an example of a timing diagram for the clock signal 1612 for mixing the I channel using the configuration shown in FIG. 16. Assuming the period of the mixing signal is 2 units, the “time” row indicates when, during the period of the sampling clock, a sampling incident is occurring, beginning from 1 and counting upward by an integer of 1, ad infinitum. The “mix” row indicates what value the input signal is essentially multiplied by, which in one embodiment is either “1” or “−1”. Finally, the “channel” row indicates which channel, the I or the Q, is being sampled. Thus, according to the timing diagram, the I channel is sampled every ½ of a sampling clock cycle.

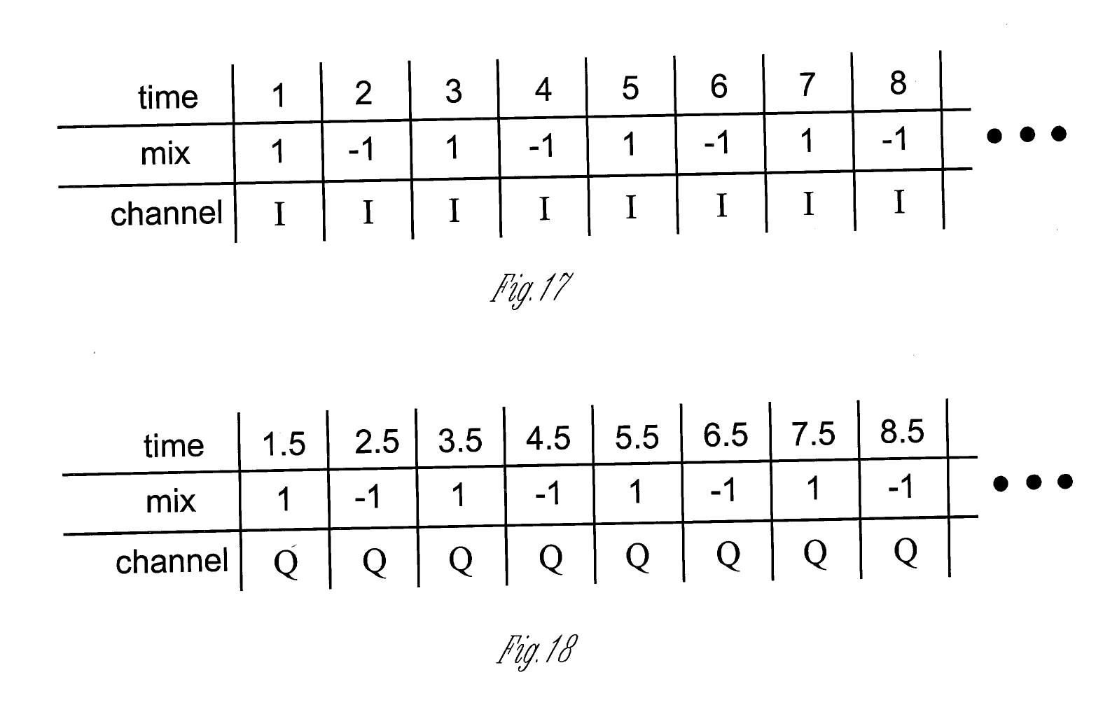

FIG. 18 illustrates an example of a timing diagram for the clock signal 1614 for mixing the Q channel using the configuration shown in FIG. 16. When viewed in conjunction with the timing diagram of FIG. 17, it shows that the “time” index for mixing the Q channel is offset from the “time” index for sampling the I channel by 0.5, or ¼ of a mixing cycle.

In various embodiments of the invention, separation of the I and Q components of an input signal is accomplished using a single ADC, rather than using the double-ADC configuration illustrated in FIG. 16.

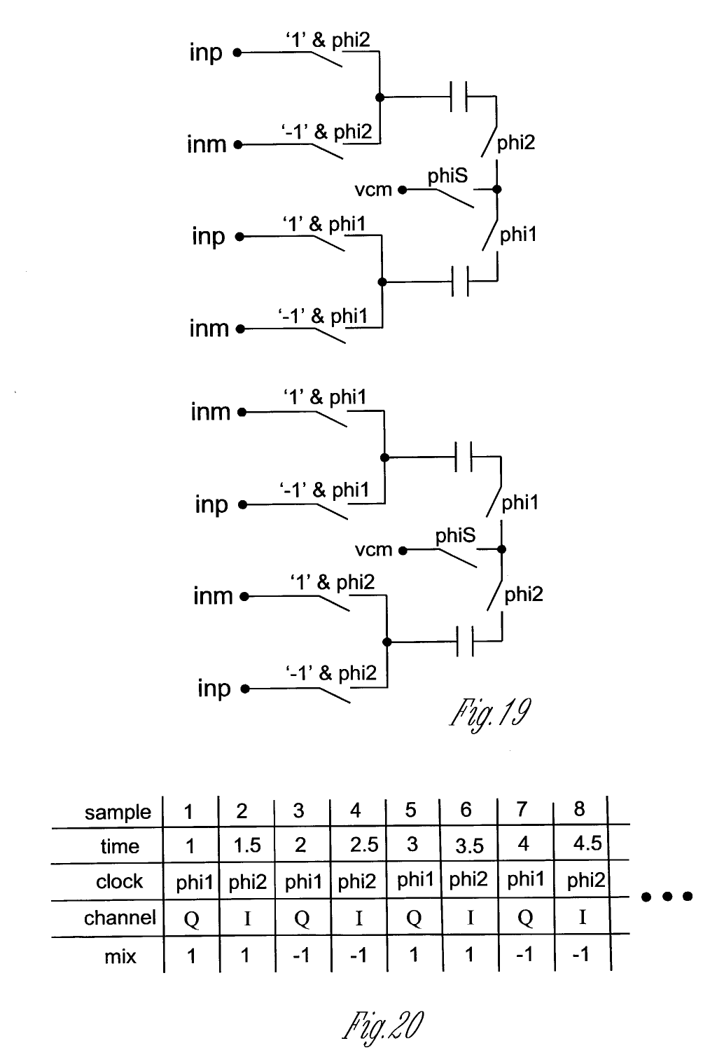

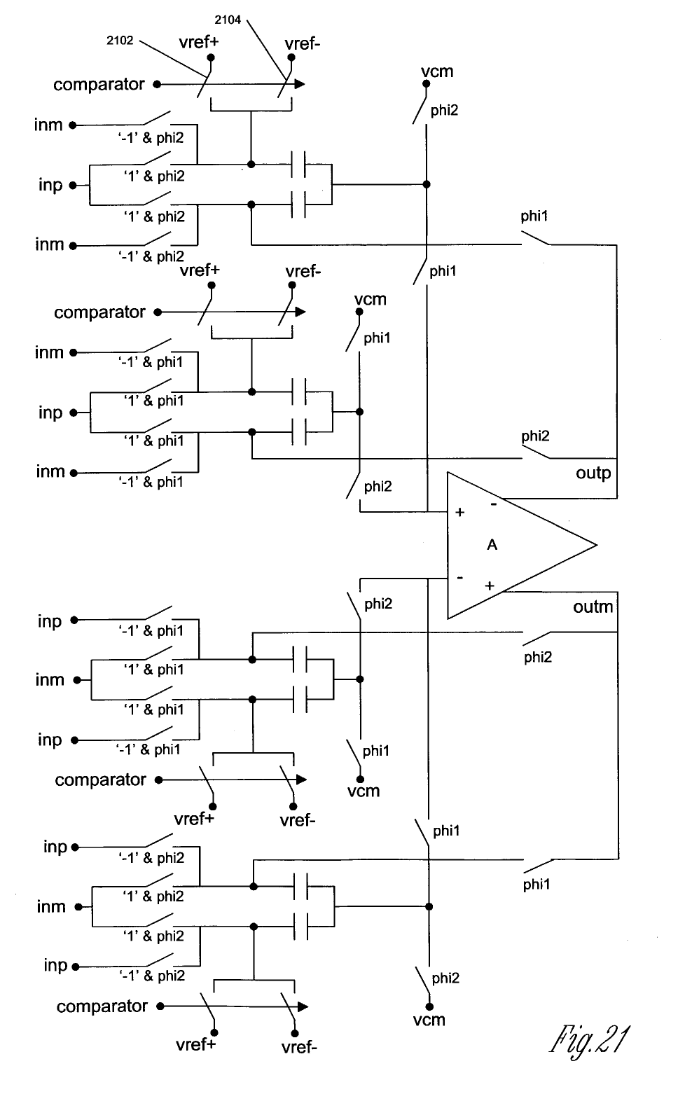

FIG. 19 illustrates I/Q demodulating, double-sampled, mixing, sampling circuitry in accordance with an embodiment of the invention. In one embodiment, the circuitry is incorporated as a front-end of a sample-and-hold circuit, and is switched according to a switching sequence that will be explained in more detail in conjunction with FIG. 20.

The circuitry illustrated in FIG. 19 is similar to the circuitry illustrated and described in conjunction with FIG. 8, as it incorporates skew-insensitive, double sampling, and downconversion. However, the circuitry illustrated in conjunction with FIG. 19 further includes the capability to separate the I and Q channels. This is accomplished, in one embodiment, by implementing a switching timing diagram, such as that illustrated in FIG. 20.

FIG. 20 illustrates an example of a timing diagram showing the clock signals for sampling and mixing the I and Q channels using the circuit illustrated in FIG. 19 in accordance with an embodiment of the invention. Basically, the timing diagram of FIG. 20 interleaves the sampling of the I and Q components, so that the sampling could be achieved using a single clock. Accordingly, assuming again a mixing period of 2 units, the “time” row indicates that a sample is taken every ¼ of a sampling clock cycle. Because the I and Q components are separated by this phase, then the samples, indicated in the “sample” row, will alternate between sampling the I channel and the Q channel. Further, the mixing coefficients, as indicated in the “mix” row, are alternated in a manner that provides the desired downconversion. Since the sampled channel alternates every other sample, the mixing coefficient follows the pattern “1,” “1,” “−1,” “−1,” “1,” “1,” ad infinitum.

As with the embodiments previously described in conjunction with FIGS. 13 and 14, some or all of the features associated with the circuit of FIG. 19 could be implemented in one of the stages (e.g., one of the modulus blocks 412) of the pipeline, with a few minor adjustments to the circuitry.

FIG. 21 illustrates a transistor-level schematic of circuitry associated with a pipeline stage in accordance with an embodiment of the invention. The circuit illustrated in FIG. 21 is similar to the circuitry illustrated in FIG. 14, except that the circuit of FIG. 21 further provides separation of the I and Q channels, when a switching sequence similar to that illustrated in FIG. 20 is implemented. The circuitry shown in FIG. 21 provides double-sampling, and also implements the modulus function using comparator switches 2102, 2104, which are connected, respectively, to positive and negative reference voltages, VREF+ and VREF−.

The circuitry associated with FIGS. 19 and 21 produce digital samples that alternate between I and Q samples. In other words, the I and Q samples produced by the ADC are interleaved, and alternate between I and Q. In one embodiment, the samples are separated by the digital processor before further processing of the digital signal occurs.

Thus, an ADC and method of its operation have been described in accordance with various embodiments. Although the ADC is described herein in the context of a pipelined converter, the invention is not limited in scope to any particular type of ADC or ADC architecture. For example, a sigma-delta ADC, a flash ADC, or another type of ADC could be employed. In addition, although the ADC has been described and illustrated using CMOS technology, other semiconductor technologies also could be used to achieve the same result. Also, the input signals could originate from a variety of signal input devices, such as a microphone, wired interface, or other circuitry that conveys or produces an analog signal. Embodiments of the invention may be used in wired or wireless devices, such as cable modems, cellular or landline telephones, computers, network interfaces, pagers, wired or wireless LAN devices, and many other types of devices.

The foregoing description of specific embodiments reveals the general nature of the invention sufficiently that others can, by applying current knowledge, readily modify and/or adapt it for various applications without departing from the generic concept. Therefore such adaptations and modifications are within the meaning and range of equivalents of the disclosed embodiments. The phraseology or terminology employed herein is for the purpose of description and not of limitation. Accordingly, it is to be understood that the appended claims are intended to cover all such alternatives, modifications, equivalents and variations as fall within the spirit of the invention.

What is claimed is:

1. A circuit comprising:
a sampling circuit configured to double-sample a first input signal and a second input signal, and to provide a first output voltage and a second output voltage to an amplifier, wherein the sampling circuit is switchable in a manner that downconverts the first input signal and the second input signal; and
the amplifier, coupled to the first sampling circuit, configured to hold the first output voltage and the second output voltage.

2. The circuit of claim 1, wherein the sampling circuit includes one or more envelope switches configured to provide a single sampling instant.

3. The circuit of claim 1, wherein the sampling circuit includes
a first half circuit coupled to the amplifier, which includes a first capacitor that is charged by the first input signal when a first set of sampling switches are closed, and a second capacitor that is charged by the second input signal when a second set of sampling switches are closed; and
a second half circuit coupled to the amplifier, which includes a third capacitor that is charged by the second input signal when a third set of sampling switches are closed, which are synchronized with the second set of sampling switches, and a fourth capacitor that is charged by the first input signal when a fourth set of sampling switches are closed, which are synchronized with the first set of sampling switches.

4. The circuit of claim 3, wherein the second half circuit is coupled to the amplifier in a manner that the second output voltage provided by the second half circuit is inverted.

5. The circuit of claim 1, wherein the sampling circuit includes
a first capacitor;
a second capacitor;
a first set of switches that are switchable together, and that are coupled to the first capacitor and the second capacitor, so that when the first set of switches is closed, the first capacitor is charged by the first input signal, and the second capacitor is charged by the second input signal;
a third capacitor;
a fourth capacitor; and
a second set of switches that are switchable together, and that are coupled to the third capacitor and the fourth capacitor, so that when the second set of switches is closed, the third capacitor is charged by the first input signal, and the fourth capacitor is charged by the second input signal, and
wherein when the first set of switches are closed, a first output voltage across the third capacitor and a second output voltage across the fourth capacitor are held by the amplifier, and when the second set of switches are closed, a third output voltage across the first capacitor and a fourth output voltage across the second capacitor are held by the amplifier.

6. The circuit of claim 1, wherein the sampling circuit is configured to downconvert the first input signal and the second input signal from an intermediate frequency to baseband.

7. The circuit of claim 1, wherein the sampling circuit is configured to separate the I and Q components of first input signal and the second input signal.

8. The circuit of claim 1, further comprising a pipelined converter, coupled to the amplifier.

9. The circuit of claim 1, wherein the circuit is a complementary metal-oxide semiconductor (CMOS) integrated circuit.

10. An apparatus comprising:
an amplifier, which receives an input signal and produces an amplified signal;
a mixer, which receives and downconverts the amplified signal to an intermediate frequency (IF) input signal;
a variable gain amplifier, which adjusts a power level of the IF input signal based on a dynamic range of an analog-to-digital converter; and
the analog-to-digital converter, which receives an amplified IF signal from the variable gain amplifier, downconverts the amplified IF signal, and converts the amplified IF signal into digital information, wherein the analog-to-digital converter includes
a sampling circuit configured to double-sample a first input signal and a second input signal, and to provide a first output voltage and a second output voltage to a second amplifier, wherein the sampling circuit is switchable in a manner that downconverts the first input signal and the second input signal,
the second amplifier, coupled to the first sampling circuit, configured to hold the first output voltage and the second output voltage, and
a converter, coupled to the second amplifier.

11. The apparatus of claim 10, wherein the sampling circuit includes one or more envelope switches configured to provide a single sampling instant.

12. The apparatus of claim 10, wherein the sampling circuit includes
a first capacitor;
a second capacitor;
a first set of switches that are switchable together, and that are coupled to the first capacitor and the second capacitor, so that when the first set of switches is closed, the first capacitor is charged by the first input signal, and the second capacitor is charged by the second input signal;
a third capacitor;
a fourth capacitor; and
a second set of switches that are switchable together, and that are coupled to the third capacitor and the fourth capacitor, so that when the second set of switches is closed, the third capacitor is charged by the first input signal, and the fourth capacitor is charged by the second input signal, and
wherein when the first set of switches are closed, a first output voltage across the third capacitor and a second output voltage across the fourth capacitor are held by the amplifier, and when the second set of switches are closed, a third output voltage across the first capacitor and a fourth output voltage across the second capacitor are held by the amplifier.

13. The apparatus of claim 10, wherein the sampling circuit is configured to downconvert the first input signal and the second input signal from an IF to baseband.

14. The apparatus of claim 10, wherein the sampling circuit is configured to separate the I and Q components of first input signal and the second input signal.

15. The apparatus of claim 10, wherein the converter is a pipelined converter.

16. A device comprising:
receive hardware, which includes
a sampling circuit configured to double-sample a first input signal and a second input signal, and to provide a first output voltage and a second output voltage to an amplifier, wherein the sampling circuit is switchable in a manner that downconverts the first input signal and the second input signal,
the amplifier, coupled to the first sampling circuit, configured to hold the first output voltage and the second output voltage, and
a converter, coupled to the amplifier, which produces digital information; and
one or more processors, coupled to the receive hardware, capable of processing the digital information.

17. The device of claim 16, further comprising an antenna, coupled to the receive hardware, which receives an analog radio frequency signal.

18. The device of claim 16, wherein the sampling circuit includes one or more envelope switches configured to provide a single sampling instant.

19. The device of claim 16, wherein the sampling circuit is configured to separate the I and Q components of first input signal and the second input signal.

20. The device of claim 16, wherein the converter is a pipelined converter.

21. A method for downconverting an analog signal and performing analog-to-digital conversion, comprising:
providing a sampling circuit that receives a differential input signal including a first input signal and a second input signal, wherein the sampling circuit includes
a first capacitor,
a second capacitor,
a first set of switches that are switchable together, and that are coupled to the first capacitor and the second capacitor,
a third capacitor,
a fourth capacitor, and
a second set of switches that are switchable together, and that are coupled to the third capacitor and the fourth capacitor;
closing the first set of switches, which causes the first capacitor to be charged by the first input signal, the second capacitor to be charged by the second input signal, and a first output voltage across the third capacitor and a second output voltage across the fourth capacitor to be provided to an amplifier;
opening the first set of switches;
closing the second set of switches, which causes the third capacitor to be charged by the first input signal, the fourth capacitor to be charged by the second input signal, and a third output voltage across the first capacitor and a fourth output voltage across the second capacitor to be provided to the amplifier; and
opening the second set of switches.

22. The method of claim 21, further comprising closing and opening one or more envelope switches of the sampling circuit, in order to provide a single sampling instant.

23. The method of claim 21, further comprising separating I and Q components of first input signal and the second input signal.

24. The method of claim 21, further comprising converting analog outputs of the amplifier into digital information using a pipelined converter.

25. A method for downconverting an analog signal and performing analog-to-digital conversion, comprising:
double-sampling a first input signal and a second input signal, using a sampling circuit, to provide a first output voltage and a second output voltage;
downconverting the first input signal and the second input signal using the sampling circuit; and
holding the first output voltage and the second output voltage.

26. The method of claim 25, wherein downconverting the first input signal and the second input signal downconverts the first input signal and the second input signal from an intermediate frequency to baseband.

27. The method of claim 25, further comprising separating the I and Q components of first input signal and the second input signal.
